(19) United States
(12) Patent Application Publication
(10) Pub. No.: US 2026/0276449 A1
(43) Pub. Date: Sep. 17, 2026

(54) TEMPERATURE SENSING UNIT AND TEMPERATURE SENSING METHOD FOR HUMAN PRESENCE DETECTION

(71) Applicant: ORIENTAL SYSTEM TECHNOLOGY INC., Hsin-Chu (TW)

(72) Inventors: Chun-Chiang CHEN, Zhubei City (TW); Chein-Hsun WANG, Hsin-Chu (TW); Jenping KU, Hsinchu County (TW)

(21) Appl. No.: 19/097,434

(22) Filed: Apr. 1, 2025

Related U.S. Application Data
(60) Provisional application No. 63/770,371, filed on Mar. 12, 2025.

(51) Int. Cl. G01J 5/00; G01J 5/12; G01J 5/80

(52) U.S. Cl. CPC G01J 5/0025; G01J 5/12; G01J 5/80

(57) ABSTRACT

A temperature sensing unit and a temperature sensing method for HPD base on non-contact thermopile sensor is proposed that can measure the in-machine temperature (Ta) and the cap temperature (Tb1) to provide the predicting external ambient temperature (Tamb) and object temperature (Tb2) for calculating the coverage ratio (CV) as

$$C V = \frac{{T}_{b 2}^{n} - {T}_{amb}^{n}}{{T}_{skin}^{n} ( Tamb ) - {T}_{amb}^{n}} .$$

Tskin is the normal skin temperature which is Tamb dependent and can be calculated from a second or third order polynomial function of Tamb. If CV exceeds a preset HPD threshold then HPD status is 1 (human presence), otherwise the HPD status is 0 (human non-presence). One implementation of the HPD detection is to use a dual thermopile sensor with one thermopile sensing element used as dummy element to detect cap temperature (Tb1), and another one used as active element for detection of human object and background temperature (Tb2).

### CROSS-REFERENCE TO RELATED APPLICATION

This patent application claims the benefit of U.S. Provisional Patent Application No. 63/770,371, filed Mar. 12, 2025, which is incorporated by reference herein.

### BACKGROUND OF THE DISCLOSURE

### Technical Field

The present disclosure relates to a temperature sensor, particularly relates to a temperature sensing unit and a temperature sensing method for human presence detection (HPD).

### Description of Related Art

A human presence detection (HPD) or occupancy sensing (OCC) is a necessary function for laptop to automatically turn OFF/ON for saving power when human is absent/presented. Several types of sensors may be used for HPD, such as Time of Fly (TOF) sensor, PIR (pyroelectric IR) sensor, CCD sensor or thermopile sensor.

TOF sensor is an optical transceiver that uses the time delay of Near IR light between reflection and transmission to estimate object distance. The TOF sensor may be difficult for using because of narrow field of view, except using with a meta lens. With the problem of higher cost of TOF sensor, people are looking for lower cost and reliable detection devices for HPD.

The cost of related-art PIR sensor is lower, and the related-art PIR sensor is widely used for energy saving in lighting control of open area, such as corridor, rest room etc. The drawback of related-art PIR sensor as HPD is that the transient detection may not be capable of using in a condition when human is presented longer than preset time period, such as more than 30 minutes.

Most of laptop computers incorporate a CDD sensor for face recognition. Due to HPD requiring high power consumption and more CPU power, a portion of CCD pixels used for HPD may not be fast enough when human is presented.

The related-art thermopile sensor is a static sensor, which is applicable for HPD application. The related-art thermopile sensor may detect human presence, which is based on skin temperature higher than ambient temperature, for required time period. Nevertheless, skin temperature may be varied according to ambient temperature, and the background temperature may also be varied. That may cause a condition that a reliable threshold for HPD is difficult to be determined. That is, it is very hard to get a reliable threshold for HPD without actual ambient temperature measurement. In the related art, several methods are proposed for determining HPD threshold, such as integral of sensed temperature in short time period (such as 1 sec) and long time period (such as 8 sec) plus on set or off set temperature change. Nevertheless, the methods have high failure rate of HPD, or even deadlock in some state of sensing flow graph.

The disclosure uses innovated algorithm to estimate ambient temperature and calculate the coverage ratio (CV) value for HPD. The detection threshold is based on maximum distance required for reliable HPD.

### SUMMARY OF THE DISCLOSURE

The disclosure provides a temperature sensing unit and a temperature sensing method, which incorporate the non-contact thermopile sensor with a calibration and calculation algorithm to provide an estimated ambient temperature, and then use that for HPD based on a threshold set by a maximum detectable distance.

One embodiment of the disclosure provides a temperature sensing unit used for HPD. The temperature sensing unit includes: a non-contact thermopile sensor, sensing an in-machine temperature (Ta), a cap temperature (Tb1) and a human object temperature (Tb2); and a processing element, calculating the coverage ratio (CV), and comparing CV with a preset HPD threshold. The realistic external ambient temperature (\hat{T}amb), which is used for normal skin temperature calculation, is important in the CV calculation. To estimate Tamb, a thermal resistance model is applied together with Ta and Tb1 sensed by the thermopile sensor. A first thermal resistance (Rac), which is between the cap temperature and an external ambient temperature, and a second thermal resistance (Ri), which is between the in-machine temperature and the cap temperature, are calculated through a calibration procedure. A predicting external ambient temperature (Tamb) is calculated according to,

$$Tamb = {T}_{b 1} - ( {T}_{a} - {T}_{b 1} ) \frac{{R}_{a c}}{{R}_{i}} .$$

One embodiment of the disclosure provides an estimation of skin temperature (Tskin) from the predicting ambient temperature (Tamb) based on a second or third order polynomial function.

One embodiment of the disclosure uses Tamb, Tskin, and Tb2 to calculate coverage ratio (CV). If CV exceeds a preset HPD threshold, HPD status is defined as 1 for human presence, otherwise HPD status is defined as 0 for human non-presence.

In some embodiment of the disclosure, CV is dependent on maximum distance for HPD. CV may be between 0.0 to 1.0.

One embodiment of the disclosure, the CV is calculated based on

$$C V = \frac{{T}_{b 2}^{n} - {T}_{amb}^{n}}{{T}_{skin}^{n} ( Tamb ) - {T}_{amb}^{n}} .$$

wherein Tb2 is sensed human object temperature, Tskin is skin temperature, and Tamb is ambient temperature. The n is equal to or less than 4. Generally, n is between 3.6-3.9 depending on the wavelength bandwidth of thermopile sensor. In some cases, n=1 is used to facilitate computation with acceptable error.

In some embodiment of the disclosure, Tamb may be obtained from an external thermal sensor such as thermistor.

One embodiment of the disclosure, the non-contact thermopile sensor is a dual-element thermopile sensor in an integrated package manner, one thermopile sensing element is used as dummy element to sense the cap temperature, and another thermopile sensing element is used as active element to sense external human object temperature through a silicon Fresnel lens disposed on top of the package. The other embodiments of the lens may be a silicon micro lens integrated on top of the silicon cap.

The other embodiment of the present disclosure, the non-contact thermopile sensor has a processing unit for the calculation and output of HPD status.

One embodiment of the disclosure provides a temperature sensing method used for HPD, which uses the ambient temperature (Tamb), the human object temperature (Tb2) and the estimated skin temperature (Tskin) to calculate CV based on

$$C V = \frac{{T}_{b 2}^{n} - {T}_{amb}^{n}}{{T}_{skin}^{n} ( Tamb ) - {T}_{amb}^{n}} .$$

If CV exceeds a preset HPD threshold (e.g., 0.3), the HPD status is defined as 1 for human presence, otherwise HPD status is defined as 0 for human non-presence. The n value is equal to or less than 4.0. Generally, the n value is between 3.6-3.9 depending on the wavelength bandwidth of thermopile sensor. In some cases, n=1.0 is used to facilitate computation with acceptable error.

Another embodiment of the disclosure, the non-contact thermopile sensor includes a non-volatile memory configured to store the ratio of the first thermal resistance and the second thermal resistance.

In summary, the temperature sensing unit and the temperature sensing method used for HPD is based on the sensed cap temperature (Tb1) to estimate the ambient temperature (Tamb), the skin temperature (Tskin) is obtained from Tamb, and CV is calculated from the sensed human object temperature (Tb2), Tskin, and Tamb. If CV exceeds a preset HPD threshold δ, then HPD status is defined as human presence. Otherwise, HPD status is defined as human non-presence.

### BRIEF DESCRIPTION OF THE DRAWINGS

FIG. 1(a) and FIG. 1(b) illustrates one of the application scenario of HPD in laptop, which FIG. 1(a) is human away from detection zone and system power OFF and FIG. 1(b) is human in detection range and system power ON.

FIG. 2 shows the average skin temperature versus ambient temperature based on normal clothing and humidity.

FIG. 3 is difference between human object temperature and ambient temperature versus ambient temperature for various CV.

FIG. 4(a) is the schematic diagram of the temperature sensing unit of the disclosure.

FIG. 4(b) is the schematic diagram of calculating the predicting ambient temperature through the cap temperature, target area temperature, and in-machine temperature.

FIG. 4(c) is the schematic diagram of calculating the predicting ambient temperature through the target area temperature and in-machine temperature.

FIG. 5 is the curve graph of predicting external ambient temperature under varied heat source during experiment.

FIG. 6 is the flowchart of the temperature sensing method for HPD.

FIG. 7 is the schematic diagram of the dual thermopile sensor of the embodiment in the disclosure.

FIG. 8 is the exploded diagram of the dual thermopile sensor of the embodiment in the disclosure.

### DETAILED DESCRIPTION

As used in the present disclosure, terms such as “first”, “second” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second” does not imply any specific sequence or order.

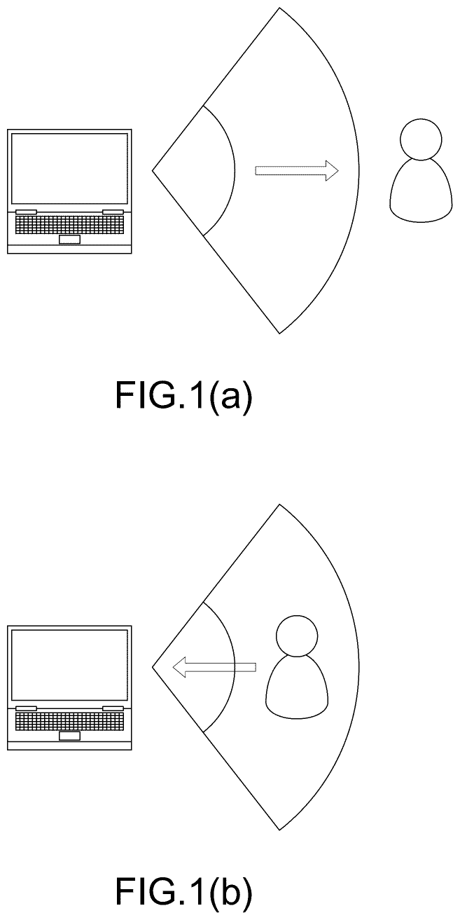

FIG. 1(a) and FIG. 1(b) illustrates one of the application scenario of HPD in laptop. In FIG. 1(a), a human object is moving away from detection zone and system power is turned OFF. In FIG. 1(b), the human object is moving into detection range and system power is turned ON.

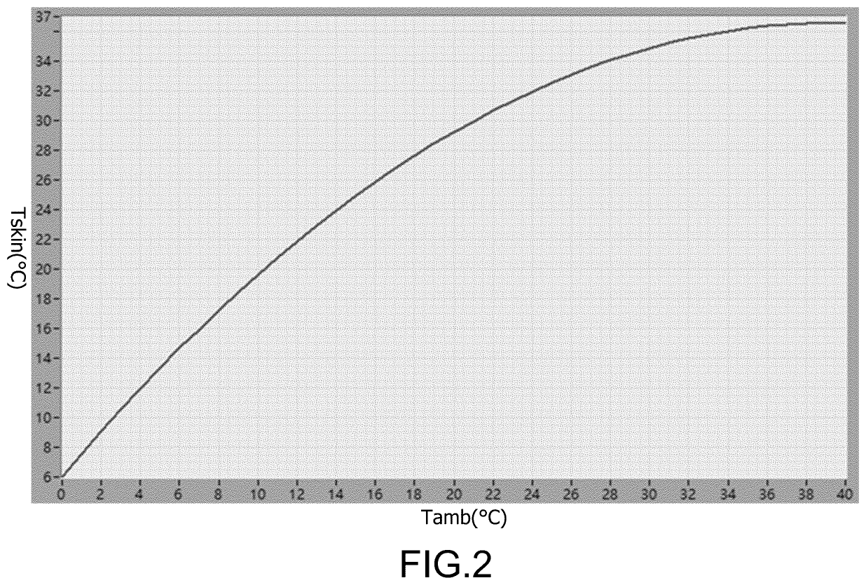

FIG. 2 shows the average skin temperature (especially face portion) versus ambient temperature based on normal clothing and humidity. As shown in FIG. 2, horizontal axis is the ambient temperature and vertical axis is the average skin (human skin) temperature. Generally, the skin temperature varies with the ambient temperature, clothing, relative humidity level, wind speed, sex gender, and age, etc. For HPD application, the normal average value is used for skin temperature, when detailed preconditions are not considered.

One embodiment of the normal skin temperature (Tskin) may be estimated based on a second or third order polynomial function of the ambient temperature (Tamb) as shown in Eq. (1).

$$Tskin = ( a 1 \times {Tamb}^{3} + ) a 2 \times {Tamb}^{2} + a 3 \times Tamb + a 4 \qquad Eq . ( 1 )$$

By using a single thermopile sensor with a fixed field of view (FOV), the sensor may detect face skin of the human object and surrounding area within a predetermined distance d. The coverage ratio (CV) may be formulated as Eq. (2).

$$C V = \frac{{T}_{b 2}^{n} - {T}_{amb}^{n}}{{T}_{skin}^{n} ( Tamb ) - {T}_{amb}^{n}} \qquad Eq . ( 2 )$$

The skin temperature (Tskin) is a function of the ambient temperature (Tamb) as in Eq. (1). Tb2 is the human object temperature detected by the thermopile sensor (i.e., face skin and surrounding area within FOV). Since the wavelength band of the thermopile sensor may be limited by the filter coating on the cover or lens, the n value may use 4.0, or the n value may use the value between 3.6-3.9 to correct the reading value. Here, CV is between 0.0 to 1.0. For simplifying the calculation of CV, n=4 or n=1 may be used with some acceptable error.

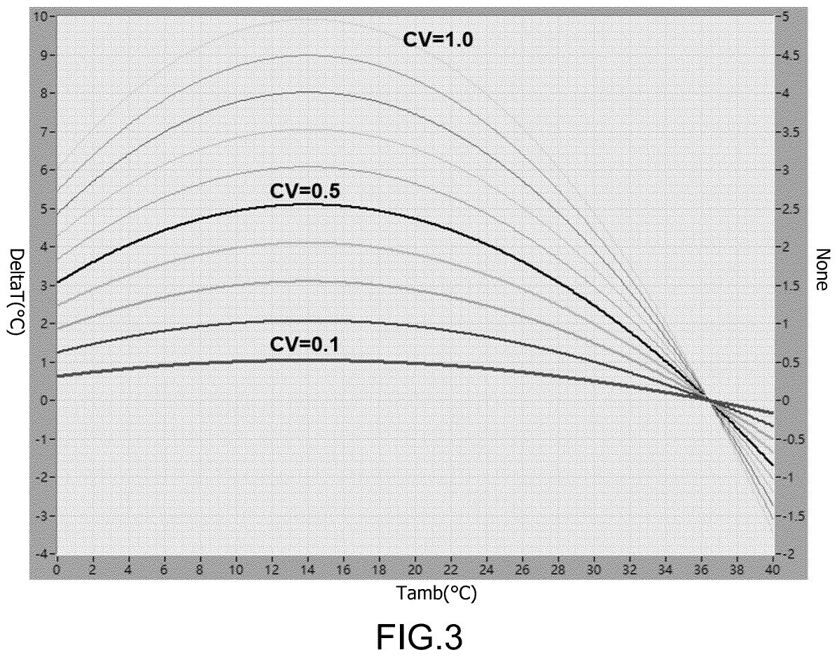

FIG. 3 is difference between human object temperature (Tb2) and ambient temperature versus the ambient temperature for various CV. As shown in FIG. 3, for a fixed CV, the difference between human object temperature (Tb2) and ambient temperature is a curve with respect to the ambient temperature (Tamb). For the ambient temperature of 36.5° C., the human object temperature is close to the ambient temperature. Therefore, the thermopile sensor may not work properly for HPD at ambient temperature of 36.5° C. Meanwhile, CV is negative for the ambient temperature higher than 36.5° C.

CV is also a function of distance, FOV and sensed area of skin as Eq. (3).

$$CV ( {Area}_{s k i n} , Distance , FOV ) = \frac{{Area}_{s k i n}}{{( 2 * Distance * tan \frac{FOV}{2} )}^{2}} \qquad Eq . ( 3 )$$

The numerator in Eq. (3) is the sensed area (including skin area and background area) under FOV and distance, while the denominator in Eq. (3) is FOV and distance. For a preset maximum distance and preset FOV of the thermopile sensor, CV is fixed. Hence, CV may be used as a preset HPD threshold for setting maximum detection distance in practical application, e.g., 60 cm or 90 cm.

Further, in FIG. 3, for a fixed CV, the difference between Tb2 and Tamb (Delta T) is a function of the ambient temperature (Tamb). Thus, HPD may be designed with variable Delta T versus the ambient temperature. In other words, with an estimated ambient temperature and a pre-selected CV (or distance), the threshold curve is obtained. As a result, any Delta T exceed the threshold is consider to be human presence. Therefore, the estimation of the ambient temperature is important for HPD to work properly based on thermopile sensor within a heated enclosure (e.g., laptop).

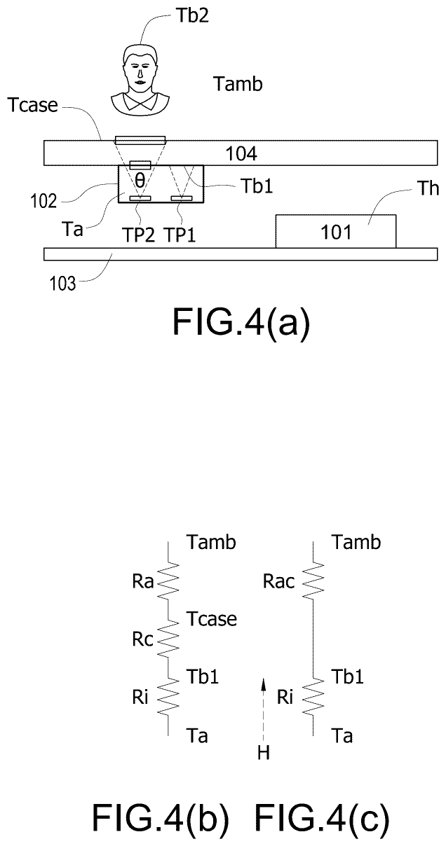

One embodiment of the disclosure, the non-contact thermopile sensor is a dual-element thermopile sensor in an integrated package manner, one thermopile sensing element is used as dummy element to sense the cap temperature for estimation of the ambient temperature Tamb, and another thermopile sensing element is used as active element to sense external human object temperature. FIG. 4(a) is the schematic diagram of the temperature sensing element of the disclosure. The non-contact thermopile sensor 102 is attached to the back side case of front LCD display in laptop with an opening for detecting human presence. In the embodiment, the non-contact thermopile sensor 102 has two thermopile sensing elements TP1, TP2 in the integrated package. The thermopile sensing element TP1 is the dummy element for detecting the cap temperature Tb1 (used as the case temperature), and the thermopile sensing element TP2 is the active element for detecting the human object (e.g., human's face) temperature Tb2. The laptop substrate 103 is used for carrying the electronic components including CPU 101. The build-in thermistor of the non-contact thermopile sensor 102 or the build-in temperature sensor of the processing element may measure the in-machine temperature Ta. The external casing temperature of the laptop 104 at the target area is Tcase, and the external ambient temperature is Tamb. FIG. 4(b) is the schematic diagram of calculating the predicting ambient temperature through the cap temperature, target area temperature, and in-machine temperature. FIG. 4(c) is the schematic diagram of calculating the predicting ambient temperature through the cap temperature and in-machine temperature. FIG. 4(b) and FIG. 4(c) show the model of the temperature at each point and the thermal resistance under the internal heat flow H. The thermal resistance (first thermal resistance) Ra is between the external casing temperature Tcase of the target area and the ambient temperature Tamb. The thermal resistance (second thermal resistance) Ri is between the in-machine temperature Ta, which is sensed by the non-contact thermopile sensor 102 or processing element, and the cap temperature Tb1 (used as the case temperature), which is sensed by the thermopile sensing element 102. Similarly, the thermal resistance (third thermal resistance) Rc is between the cap temperature Tb1 and the external casing temperature Tcase at the target area. For analyzing, the thermal resistances Ra and Rc may be simplified as Rac as shown in FIG. 4(c) to acquire the ambient temperature Tamb based on the cap temperature Tb1 (used as the case temperature).

Under thermal equilibrium, the ambient temperature Tamb may be obtained by the in-machine temperature Ta, the cap temperature Tb1, and the first ratio Rac/Ri as shown in Eq. (4).

$$H = \frac{{T}_{a} - {T}_{b 1}}{{R}_{i}} = \frac{{T}_{b 1} - {T}_{a m b}}{{R}_{a c}} \to Tamb = {T}_{b 1} - ( {T}_{a} - {T}_{b 1} ) \frac{{R}_{a c}}{{R}_{i}} \qquad Eq . ( 4 )$$

The ratio Rac/Ri may be obtained through calibration process under thermal equivalent state as listed in Eq. (5).

$$\frac{{R}_{a c}}{{R}_{i}} = \frac{{T}_{b 1}^{*} - {T}_{a m b}^{*}}{{T}_{a}^{*} - {T}_{b 1}^{*}} \qquad Eq . ( 5 )$$

Tb1*, Ta* are the readouts of the cap temperature and the in-machine temperature from the non-contact thermopile sensor 102, respectively. T*amb is the measured external ambient temperature during the calibration process.

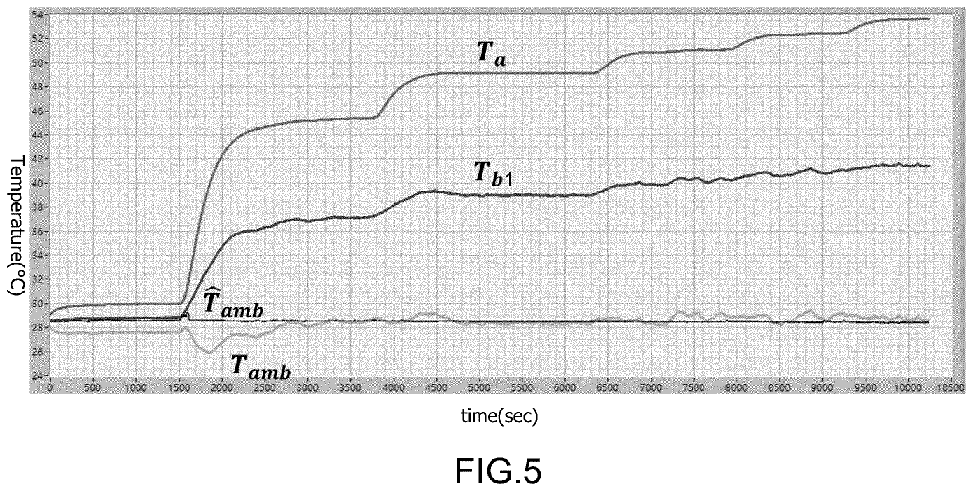

FIG. 5 is the curve graph of predicting external ambient temperature under varied heat source during experiment. From Top to bottom, four curves are the in-machine temperature Ta, the cap temperature Tb1 (as the case temperature) from the thermopile sensing element TP1, the realistic external ambient temperature \hat{T}amb, and the predicting external ambient temperature Tamb, respectively. As shown in FIG. 5, during the stage that the in-machine temperature Ta is beginning to increased, the predicting external ambient temperature Tamb has an error of about 2° C. comparing to the realistic external ambient temperature \hat{T}amb. Afterward, the predicting external ambient temperature Tamb is substantially the same as the realistic external ambient temperature \hat{T}amb. The estimation error of ambient temperature is larger when the heat source is increasing. Even at the transition stage, the estimation error to the ambient temperature is within 1° C., which proves the effectiveness of the disclosure in predicting the external ambient temperature based on thermal resistance model.

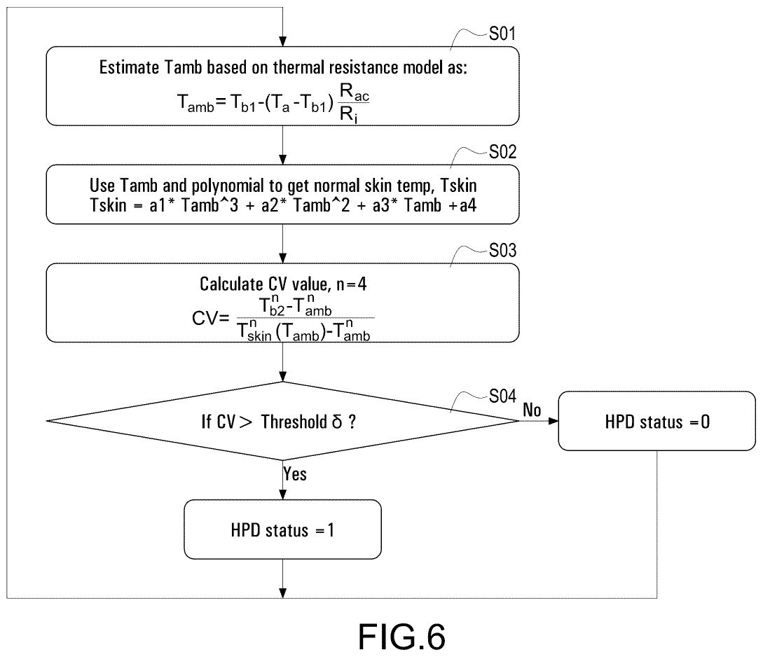

FIG. 6 is the flowchart of the temperature sensing method for HPD. As shown in FIG. 6, the step S01 is using the pre-calibrated thermal resistance ratio Rac/Ri and Eq. (4) to estimate the ambient temperature Tamb based on the thermopile sensing element TP1 (dummy element).

$$Tamb = {T}_{b 1} - ( {T}_{a} - {T}_{b 1} ) \frac{{R}_{a c}}{{R}_{i}}$$

Tb1, Ta are the readouts of the cap temperature and the in-machine temperature from the non-contact thermopile sensor 102, respectively.

The step S02 is using the ambient temperature Tamb to get the normal skin temperature Tskin by Eq. (1).

The step S03 is calculating the CV value based on the human object temperature Tb2, the ambient temperature Tamb and the normal skin temperature Tskin by Eq. (2). The n value is defined to be 4.0 (n=4.0).

The step S04 is determining whether CV is greater than the preset HPD threshold δ. If the calculated CV exceeds the preset HPD threshold δ (e.g., 0.3), then the HPD status is defined to be 1 for human presence, otherwise, the HPD status is defined to be 0 for human non-presence. The HPD threshold δ is also related to the sensing distance, which may be estimated from Eq. (3). In general, the HPD threshold δ is between 0.1-0.5, 0.3 is more preferable.

In another embodiment, the ambient temperature may be obtained through another temperature sensor for external air temperature measurement, e.g., a thermistor exposed to outside air.

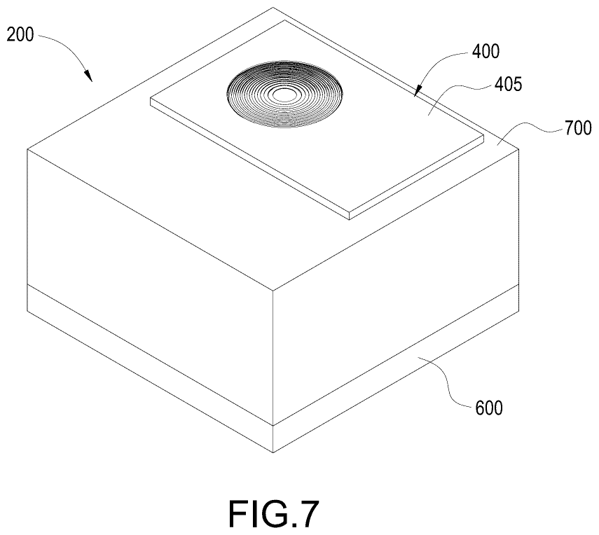

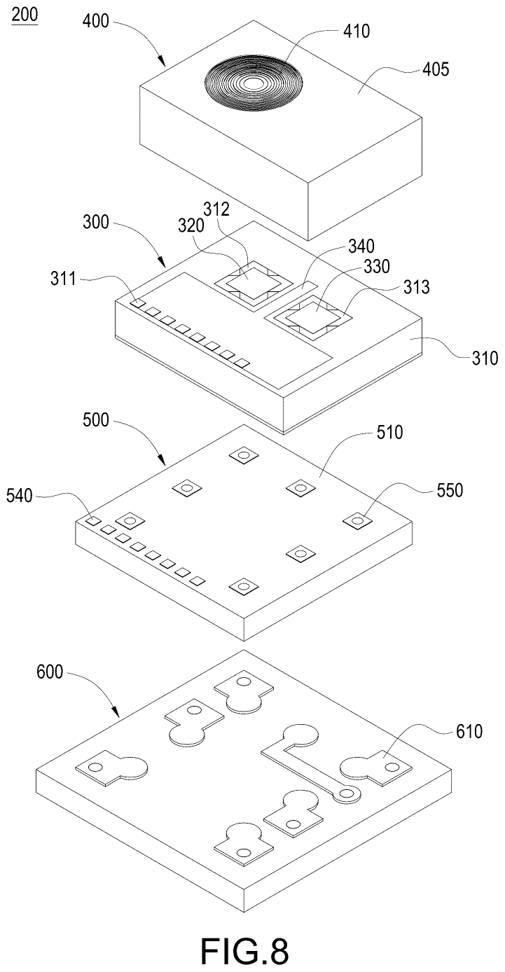

Referring to FIG. 7 and FIG. 8, in some embodiments, the dual thermopile sensor 200 may, for example, include an infrared sensing chip 300, a silicon cover 400, a microcontroller chip 500, a package substrate 600, and a sealing encapsulation 700.

The infrared sensing chip 300 includes a first substrate 310, a first thermopile sensing element 330 (TP1), a second thermopile sensing element 320 (TP2), and a front-end signal processing unit 340. In some embodiments, the first substrate 310 has a wire-bonding pad 311 and two membrane structures (or floating plate structures) 312, 313 formed by a front-side wet etching. The wire-bonding pad 311 and the membrane structures 312, 313 are disposed correspondingly. In some embodiments, the wire-bonding pad 311 is disposed on the edge of the first substrate 310 for wire bonding to the microcontroller chip 500, and the membrane structures 312, 313 are disposed away from the wire-bonding pad 311 and disposed corresponding to the silicon cover 400. In some embodiments, the first substrate 310 further includes two concave portions corresponding to the membrane structures 312, 313 respectively.

The first thermopile sensing element 330 is disposed on the membrane structure 313. A hot junction of the first thermopile sensing element 330 is located on the membrane structure 313, and a cold junction of the first thermopile sensing element 330 is located on the periphery of the concave portion. The first thermopile sensing element 330 may sense the cap temperature Tb1 (used as the case temperature).

In some embodiments, the second thermopile sensing element 320 is disposed on the membrane structure 312. The second thermopile sensing element 320 is disposed adjacent to the first thermopile sensing element 330. A hot junction of the second thermopile sensing element 320 is located on the membrane structure 312, and a cold junction of the second thermopile sensing element 320 is located on the periphery of the concave portion. The window portion of the second thermopile sensing element 330 is covered by a Fresnel lens 410, thereby the second thermopile sensing element 320 may sense the thermal radiation of the human object temperature with the ambient radiation, which is used as the human object temperature Tb2.

In some embodiments, the front-end signal processing unit 340 is disposed on the first substrate 310 and electrically connected with the first thermopile sensing element 320 and the second thermopile sensing element 330. The signal processing unit 340 has nonvolatile memory for the storage of thermal resistance ratio (Rac/Ri). The nonvolatile memory may be EEPROM (Electrically Erasable Programmable Read-Only Memory), Flash, MTP (Multiple Programming Memory) or OTP (One Time Programming Memory), here is not intended to be limiting.

In some embodiments, the Fresnel lens 410 of the silicon cover 400 may be manufactured by a semiconductor process. The Fresnel lens 410 set the FOV of the thermopile sensor 200. In some embodiments, the FOV of thermopile sensor 200 is designed between 40-70 degrees. The second thermopile sensing element (TP2) 320 is disposed corresponding to the Fresnel lens 410, and the first thermopile sensing element 330 is disposed corresponding to the surface 405 of the silicon cover 400.

In summary, the disclosure provides a temperature sensing unit and a temperature sensing method for human presence detection (HPD) that can be used in laptop for automatically controlling the system power to be ON/OFF for energy saving and user data privacy protection. In one embodiment, the dual thermopile sensor with one dummy element (TP1) to estimate ambient temperature based on thermal resistance model and another active element (TP2) to detect external radiation for human subject presence detection.

While this disclosure has been described by means of specific embodiments, numerous modifications and variations may be made thereto by those skilled in the art without departing from the scope and spirit of this disclosure set forth in the claims.

What is claimed is:

1. A temperature sensing unit, used for human presence detection (HPD), the temperature sensing unit comprising:
a non-contact thermopile sensor, configured to sense an in-machine temperature (Ta) and a human object temperature (Tb2); and
a processing element, configured to calculate the normal skin temperature (Tskin) at an ambient temperature (Tamb) and a coverage ratio (CV) based on the ambient temperature (Tamb) as below,
$$C V = \frac{{T}_{b 2}^{n} - {T}_{amb}^{n}}{{T}_{skin}^{n} ( Tamb ) - {T}_{amb}^{n}} ,$$
wherein, n is equal to or greater than 1.0 and equal to or less than 4.0;
when the CV is greater than a preset HPD threshold δ, a HPD status is defined to be 1 for human presence;
when the CV is equal to and less than the preset HPD threshold δ, the HPD status is defined to be 0 for human non-presence.

2. The temperature sensing unit according to claim 1, wherein the ambient temperature (Tamb) is obtained from a temperature sensor.

3. The temperature sensing unit according to claim 1, wherein the non-contact thermopile sensor is a dual thermopile sensor, the dual thermopile sensor comprises two thermopile sensing elements, one of the thermopile sensing element is a dummy element for sensing of a cap temperature (Tb1), another one of the thermopile sensing element is an active element for sensing the human object temperature (Tb2).

4. The temperature sensing unit according to claim 3, wherein the non-contact thermopile sensor comprises a Fresnel lens, the Fresnel lens defines a field of view (FOV) of the active element.

5. The temperature sensing unit according to claim 3, wherein the ambient temperature (Tamb) is obtained based on the cap temperature (Tb1) from the dummy element with a thermal resistance model as below,
$$Tamb = {T}_{b 1} - ( {T}_{a} - {T}_{b 1} ) \frac{{R}_{a c}}{{R}_{i}} ,$$
wherein Rac is a thermal resistance between the cap temperature to an external ambient temperature, Ri is a thermal resistance between the in-machine temperature and the cap temperature.

6. The temperature sensing unit according to claim 1, wherein the normal skin temperature (Tskin) is obtained based on the ambient temperature (Tamb) with a second order polynomial function or a third order polynomial function as below,
Tskin=(a1×Tamb³+)a2×Tamb²+a3×Tamb+a4, where a1=0 is a second order polynomial.

7. The temperature sensing unit according to claim 1, wherein n in the CV is equal to or greater than 1.0 and equal to or less than 4.0.

8. The temperature sensing unit according to claim 1, wherein the preset HPD threshold δ is equal to or greater than 0.1 and equal to or less than 0.5.

9. The temperature sensing unit according to claim 1, wherein the preset HPD threshold δ is 0.3.

10. The temperature sensing unit according to claim 1, wherein the processing element comprises a nonvolatile memory configured to store a calibrated thermal resistance ratio (Rac/Ri).

11. The temperature sensing unit according to claim 10, wherein the nonvolatile memory is an EEPROM, a Flash, a MTP or an OTP.

12. A temperature sensing method, used for human presence detection (HPD), the temperature sensing method comprising:
sensing an in-machine temperature (Ta) and a cap temperature (Tb1) and a human object temperature (Tb2);
calculating an ambient temperature Tamb based on,
$$Tamb = {T}_{b 1} - ( {T}_{a} - {T}_{b 1} ) \frac{{R}_{a c}}{{R}_{i}} ,$$
wherein a first ratio of a first thermal resistance (Rac), which is between the cap temperature (Tb1) and an external ambient temperature, and a second thermal resistance (Ri), which is between the in-machine temperature (Ta) and the cap temperature (Tb1) is obtained through a first calibration procedure;
calculating a normal skin temperature (Tskin) from the ambient temperature (Tamb) based on a second order polynomial function or a third order polynomial function as, Tskin=(a1×Tamb³+)a2×Tamb²+a3×Tamb+a4;
calculating a coverage ratio (CV) based on,
$$C V = \frac{{T}_{b 2}^{n} - {T}_{amb}^{n}}{{T}_{skin}^{n} ( Tamb ) - {T}_{amb}^{n}} ;$$
and
determining a HPD status to be 1 for human presence when the CV is greater than a preset HPD threshold δ, and determining a HPD status to be 0 for human non-presence when the CV is equal to or less than the preset HPD threshold δ.

13. The temperature sensing method according to claim 12, wherein the preset HPD threshold δ is equal to or greater than 0.1 and equal to or less than 0.5.

14. The temperature sensing method according to claim 13, wherein the preset HPD threshold δ is 0.3.
